(19) United States
(12) Patent Application Publication
(10) Pub. No.: US 2020/0065112 A1
(43) Pub. Date: Feb. 27, 2020

(54) ASYMMETRIC SPECULATIVE/NONSPECULATIVE CONDITIONAL BRANCHING

(71) Applicant: QUALCOMM Incorporated, San Diego, CA (US)

(72) Inventor: Kevin Christopher GOTZE, Hillsboro, OR (US)

(21) Appl. No.: 16/109,402

(22) Filed: Aug. 22, 2018

(51) Int. Cl. G06F 9/38; G06F 9/30; G06F 21/55

(52) U.S. Cl. CPC G06F 9/3844; G06F 2221/034; G06F 21/554; G06F 9/30058

(57) ABSTRACT

Several features pertain to processors equipped for speculative execution of processor code following a branch prediction. As described herein, asymmetric conditional branch instructions are provided for use by programmers and/or compilers to block speculation along one branch pathway while allowing speculation along another pathway. That is, a new type of branch instruction is described in which the encoding specifies that it is asymmetrically speculative (or asymmetrically nonspeculative). Techniques are also described for protecting sensitive information from certain types of malicious attacks, such as side-channel attacks, by employing asymmetrically speculative/nonspeculative conditional branching. For example, an asymmetric branch instruction may be used to block speculation along a vulnerable branch that exposes sensitive information to a side-channel attack, while nevertheless allowing speculation along another branch. Various examples are described herein, including system, method and apparatus implementations.

### BACKGROUND

### Field of the Disclosure

Various features relate to computing systems and more particularly to preventing access to secure or sensitive resources or content.

### Description of Related Art

State-of-the-art central computing systems (CPUs) often employ speculative execution and/or branch prediction to enhance performance A possible security vulnerability may arise whereby an attacker exploits speculative access to data prior to the CPU confirming the correctness of that access. The attack may include a side-channel attack (such as a cache side-channel attack or branch predictor side-channel attack). This may have adverse consequences for the security of sensitive data (e.g. cryptographic keys stored in memory) for which confidentiality must be maintained from attackers in peer or lower privilege levels. One example of such a vulnerability is the so-called Spectre vulnerability, which affects Intel x86 microprocessors, IBM POWER processors, and some ARM-based microprocessors. (Intel, IBM and ARM are trademarks of their respective companies.)

It would be desirable to provide mitigations to address these or other issues.

### SUMMARY

In one aspect, a method is provided for use by a processor, the method including: receiving processor code that includes an asymmetric conditional branch instruction that permits speculative execution along one of first and second branches while blocking speculative execution along the other of the first and second branches; and executing the processor code using circuitry of the processor configured to execute asymmetric conditional branch instructions.

In another aspect, a processor includes: a receive device configured to receive processor code having an asymmetric conditional branch instruction, the asymmetric conditional branch instruction permitting speculative execution along one of first and second branches while blocking speculative execution along the other of the first and second branches; and code execution circuitry configured to execute processor code instructions, including the asymmetric conditional branch instruction.

In yet another aspect, a method is provided for use by a compiler for converting a computing program to processor code for executing on a processor. The method includes: identifying a conditional processing branch in the computing program, the conditional processing branch having a first branch and a second branch; compiling the computing program into processor code, the processor code including an asymmetric conditional branch instruction inserted at the conditional processing branch to instruct the processor to permit speculative execution along one of the first and second branches while blocking speculative execution along the other of the first and second branches; and storing the processor code on an non-transitory machine-readable storage medium for subsequent execution by the processor.

In still another aspect, a compiler is configured for converting a computing program to processor code for executing on a processor. The compiler includes: a receive component configured to receive a computer program for compiling; a conditional processing branch identifier configured to identify at least one conditional processing branch in the computing program; and a code compiler configured to compile the computing program into processor code, the processor code including an asymmetric conditional branch instruction inserted at the conditional processing branch to instruct the processor to permit speculative execution along one of the first and second branches while blocking speculative execution along the other of the first and second branches.

### BRIEF DESCRIPTION OF THE DRAWINGS

FIG. 1 is a block diagram illustrating exemplary components of a computing and/or processing system configured to implement or execute asymmetric conditional branch instructions.

FIG. 2 is a diagram illustrating branch prediction and speculative execution.

FIG. 3 includes diagrams illustrating the use of asymmetric conditional branch instructions.

FIG. 4 is a flow diagram summarizing exemplary procedures for use by a computing system to implement asymmetric conditional branch instructions.

FIG. 5 is a flow diagram summarizing exemplary procedures to generate processor code with asymmetric conditional branch instructions.

FIG. 6 illustrates an exemplary system-on-a-chip (SoC) wherein the SoC includes components to implement asymmetric conditional branch instructions.

FIG. 7 is a block diagram illustrating another example of a hardware implementation for an apparatus employing a processing system that may exploit the systems, methods and apparatus described herein.

FIG. 8 is a high level flow diagram summarizing exemplary procedures for implementing asymmetric conditional branch instructions.

FIG. 9 is a flow diagram that further summarizes exemplary procedures for implementing asymmetric conditional branch instructions.

FIG. 10 is a flow diagram that still further summarizes exemplary procedures for implementing asymmetric conditional branch instructions.

FIG. 11 is a high level block diagram illustrating exemplary components of a processor configured to implement asymmetric conditional branch instructions.

FIG. 12 is another block diagram that further illustrates exemplary components of a processor configured to implement asymmetric conditional branch instructions.

FIG. 13 is a high level flow diagram illustrating an exemplary method for compiling processor code to include asymmetric conditional branch instructions.

FIG. 14 is a high level flow diagram further illustrating an exemplary method for compiling processor code using asymmetric conditional branch instructions.

FIG. 15 is a high level block diagram illustrating exemplary components of a compiler configured to compile code with asymmetric conditional branch instructions.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure.

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation.

### Overview

Several features pertain to methods and apparatus for use with computing systems equipped perform speculative execution. As noted above, problems can arise in speculating processing systems as a result of malicious attacks that seek to obtain sensitive or secure information by exploiting speculative execution of specific vulnerable sequences of instructions. Attackers using software running in a low privilege mode can induce the processor to follow speculative execution paths or branches in a higher privileged mode that speculatively accesses sensitive memory. Even if the processor subsequently flushes the results of the speculative execution, the attacker may exploit side-channel analysis to reveal bits stored in the sensitive memory to reveal cryptographic keys or the like. In this regard, at least some processors have been designed under the assumption that the aborted results of speculative execution will not be vulnerable to malicious attacks so long as the misspeculated results are flushed. An attacker can exploit the vulnerability unless steps are takes to mitigate or eliminated the vulnerability.

Herein, techniques are described whereby sensitive data is protected from the aforementioned attacks by employing asymmetrically speculative/nonspeculative conditional branching, such as by using asymmetric conditional branch instructions within computing systems that use branch prediction and perform speculative execution.

Branch prediction is ordinarily a microarchitectural feature of a processing system hidden from programmers (and omitted from the instruction set architecture (ISA) specification). However, in light of the security concerns raised by the Spectre attacks, it may be appropriate to expose more details of branch prediction to programmers/compilers so as to mitigate the attacks without significant performance loss.

Some techniques have been proposed that provide special instructions for blocking speculative execution that can be inserted into code (e.g. by a programmer) before other conventional instructions to provide a barrier to stop speculation. That is, the combined consequence of the new instruction and the conventional branch instruction is to block speculative branch behavior. See, for example, the LFENCE instruction of Intel and the CSDB instruction of ARM. By placing one of the instructions before conventional branch instructions or vulnerable code sequences, certain attacks might be prevented or otherwise mitigated. The added instruction combinations might be referred to as “symmetric” conditional branch instructions because they have the effect of blocking speculation along both branch pathways of a conditional branch. However, significant performance loss can occur when using these instructions because the benefits of branch prediction are greatly reduced. Alterative added instruction sequences that place a Barrier instruction on one of the branch pathways incur the potential power and performance penalties of misspeculating down the protected pathway without the benefit of speculatively executing past the barrier instruction.

Herein, techniques are instead described wherein “asymmetric” conditional branch instructions are provided for use by programmers and/or compilers to block speculation along one branch pathway while allowing speculation along another pathway. That is, at least some conventional branch instructions are replaced with new asymmetric conditional branch instructions that are intrinsically and explicitly asymmetric. (This differs from LFENCE/CSDB, discussed above, which are additional instructions placed before conventional branch instructions.) That is, a new type of branch instruction is described herein whose encoding specifies that it is asymmetrically speculative (or asymmetrically nonspeculative). Using these new instructions, a “classical” branch instruction may be replaced with an “asymmetric conditional branch instruction” (which may also be referred to as an “asymmetric speculative branch instruction” or an “asymmetric non-speculative branch instruction” or other suitable or equivalent terms).

Aspects of the techniques described herein exploit the recognition that conditional branches (e.g. branches that may be Taken or Not Taken depending on a condition in the architectural state) may have one pathway that is risky or dangerous to speculate along (e.g. vulnerable to a side-channel attack or other attack by malicious entities) while the other pathway is relatively or comparatively safe to speculate along. Asymmetric conditional branch instructions thus allow speculation to proceed down one of the two pathways but not both.

In an illustrative example, two versions of an instruction are provided: Nonspeculative Taken and Nonspeculative Not Taken), which can be used in code to allow speculation only along one of the two potential execution pathways. Compilers are configured or programmed to insert the asymmetric instructions in code to prevent the processor from speculating along a vulnerable pathway, while not preventing speculation along the other (safe) pathway. (Depending upon the branch, the vulnerable pathway might be the predicted Taken pathway or the Not Taken pathway; hence the use of two versions of the instruction.) With this technique, attacks may be mitigated by blocking speculation only along vulnerable pathways without significant performance loss (since many or most pathways are not vulnerable to the aforementioned attacks and speculation is still permitted along those pathways).

### Exemplary Asymmetric Conditional Branch Instruction Systems and Procedures

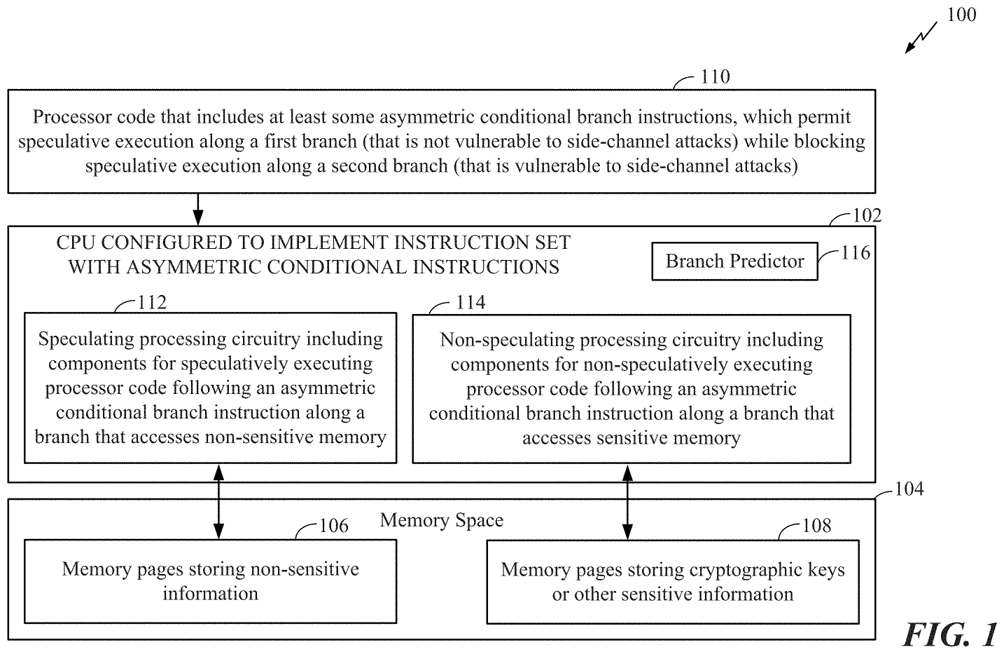

FIG. 1 illustrates an exemplary computing system 100 that includes a CPU 102 and a memory space 104. The memory space 104 includes memory pages 106 storing non-sensitive information such as routine data, and memory pages 108 storing sensitive information such as cryptographic keys. The memory space may be formed using any of a variety of memory components, such as static random access memory (SRAM), dynamic RAM (DRAM), etc. The CPU 102 receives processor code 110 that includes at least some asymmetric conditional branch instructions, which permit speculative execution along a first branch (that is not vulnerable to side-channel attacks) while blocking speculative execution along a second branch (that is vulnerable to side-channel attacks). For example, the asymmetric conditional branch instructions may block speculative execution along branches that access the sensitive memory pages 108 while permitting speculative execution along branches that access non-sensitive pages 106.

The CPU 102 is configured to implement an instruction set that includes such asymmetric conditional branch instructions. That is, the CPU 102 is configured to implement asymmetrically speculative/nonspeculative conditional branching by executing asymmetric conditional branch instructions that permit speculative execution along one branch while blocking speculative execution along another branch. As can be appreciated by those skilled in the art, there are many ways to implement an instruction set architecture within a processing system, such as by hardwiring the functions of the instructions into a processor and/or using microcode, etc. The asymmetric conditional branch instructions of FIG. 1 (and the overall instruction set) may be implemented using any suitable method or technology, which may depend upon the particular processor design. For example, the CPU may include hardware (HW) and/or firmware (FW) components that execute processor code and implement the instruction set.

Within FIG. 1, to clearly illustrate the different functions associated with speculative and non-speculative processing, the CPU is shown as having speculating processing circuitry 112 (e.g. circuitry configured for the speculative execution of code) and a non-speculating processing circuitry 114 (e.g. circuitry configured for the non-speculative execution of code). A branch predictor 116 is also shown. By “speculating circuitry,” it is meant that the circuitry is equipped or configured to speculatively execute code (such as machine language programming code that includes a set of instructions) or other operations, instructions or programs One form of speculative execution is predictive execution where an outcome is predicted and execution proceeds along a predicted pathway until the actual result is known. For example, code along a branch that the branch predictor 116 has predicted will be taken may be speculatively executed with the results held in memory and committed only if the prediction is eventually found to be correct (and the results are flushed otherwise). By “non-speculating circuitry,” it is meant that the circuitry does not perform such speculation. For example, the non-speculating circuitry may wait until a conditional branch in the processor code has been resolved and then executes the code along the branch that has been taken. With non-speculative execution, results may be committed promptly or immediately upon execution.

More specifically, in the example of FIG. 1, the speculating processing circuitry 112 includes components for speculatively executing processor code following an asymmetric conditional branch instruction along a branch that accesses non-sensitive memory (such as non-sensitive memory pages 106). The non-speculating processing circuitry 114 includes components for non-speculatively executing processor code following the asymmetric conditional branch instruction along a branch that accesses sensitive memory. That is, when an asymmetric conditional branch instruction is reached in the processing code, if the predicted branch accesses sensitive pages (or the branch is otherwise risky or dangerous to speculate along), the non-speculating processing circuitry 114 handles the processing of the branch instruction and waits until the branch prediction is resolved before executing the code following the branch instruction. If the predicted branch does not access sensitive pages (or the branch is otherwise not risky or not dangerous to speculate along), the speculating processing circuitry 112 handles the processing of the instruction by performing speculative execution along the predicted branch. The results are held in memory until the branch prediction is resolved, then committed or flushed (depending upon whether the prediction was correct or not).

Although the speculating processing circuitry 112 and the non-speculating processing circuitry 114 are shown separately to highlight their different functions, it should be understood that physically separate circuitry or circuits need not be employed. Rather, in some examples, a single processor or single set of processing circuits may be configured to perform both speculative and non-speculative execution, using many of the same components, sub-components or other shared features or circuits. Although not shown in FIG. 1, code execution may be pipe-lined and/or implemented out-of-order.

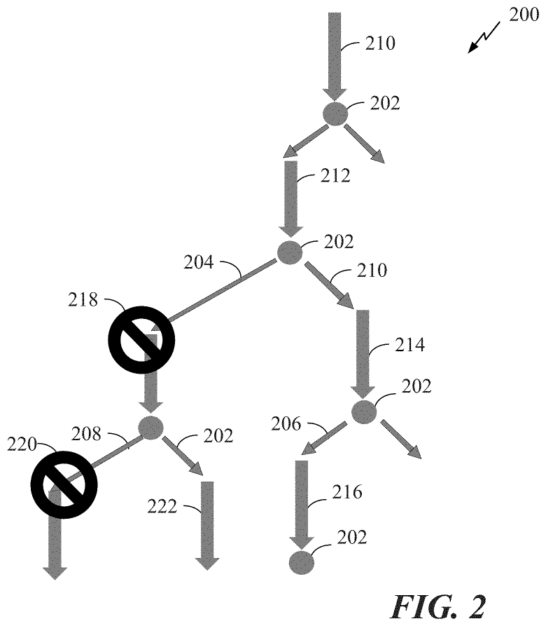

FIG. 2 illustrates speculative execution using conditional branching. The conditional branching graph 200 of FIG. 2 illustrates that there can be many potential branching paths for processor code to execute along, with the code transitioning from one state to another (and with the states generally denoted by reference numeral 202). Speculation precedes the actual architectural execution flow (which must wait until conditional branches are resolved). In FIG. 2, speculatively executed branches include branches 204, 206, and 208. Architectural flow includes branches 210, 212, 214, and 216. When a misprediction is detected, the speculative execution can be rolled back, as indicated by the “stop” icons 218 and 220, so that the correct architectural flow can then be followed. It is noted that, in the example of FIG. 2, branch 222 is never executed, either speculatively or non-speculatively, since branch 222 represents a side branch along a speculative branch that is rolled back due to an earlier misprediction.

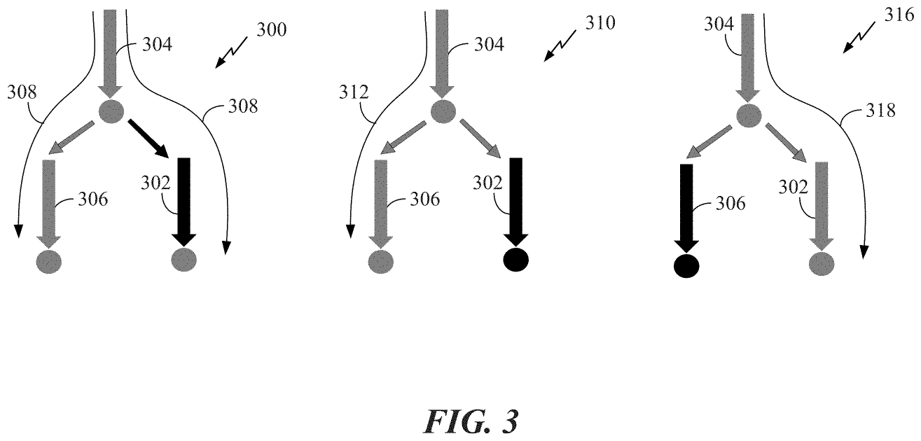

FIG. 3 illustrates three simplified branching examples. The first example 300 illustrates that, in some cases, one of the possible branches can represent a dangerous path. In the example, branch path 302 represents the risky path, which might access sensitive information in memory and thus might expose that information to speculative side-channel attacks or the like. Paths 304 and 306 represent the correct architectural flow. The two thin arrows 308 indicate that either path might be predicted by a branch predictor. Speculation along branch 302 would be inappropriate, since it risks exposing sensitive information. Speculation along branch 306 is not a problem since sensitive information is not at risk.

Exemplary instruction code for use with example 300 is as follows:

| | |
|---|---|
| CMP X1, #value | ; |
| BLT over | ; Branch Less Than |
| LDR X1, [X2] | ; speculative side-channel risk |
| LSL X1, X1, #4 | ; |

LDR X3, [X1]

Over

LSL X1, X1 #8
...

The instructions “LDR X1, [X2],” “LSL X1, X1, #4,” and “LDR X3, [X1]” following BLT are the instructions on the risky branch for which speculation should be blocked. The instruction “LSL X1, X1#8” is on the safe branch for which speculation should be allowed.

The second example 310 of FIG. 3 illustrates that, by using an asymmetric branch instruction, speculation along one of two possible branches can be blocked. In the example, path 302 again represents a risky path, and paths 304 and 306 represent the correct architectural flow. A single thin arrow 312 indicates that only the safe path can be speculated along, e.g. path 306. Speculation along branch 302 is blocked since it risks exposing sensitive information.

Exemplary instruction code for use with example 310 is as follows, which instead uses BLTNSNT, rather than BLT:

| | |
|---|---|
| CMP X1, #value | ; |
| BLTNSNT over | ; Branch Less Than, No Speculation along |

Not Taken Branch

| | |
|---|---|
| LDR X1, [X2] | ; speculative side-channel risk |
| LSL X1, X1, #4 | ; |

LDR X3, [X1]

Over

LSL X1, X1 #8
...

BLTNSNT is an asymmetric conditional branch instruction that blocks speculation down the “Not Taken” code path, thus avoiding the risky pathway, while still allowing speculation to proceed down the “Taken” path if the branch predictor predicts that pathway.

The third example, 316, of FIG. 3 illustrates an alternative No Speculation on Taken example of the asymmetric conditional branch instruction, which prevents speculation along the “Taken” pathway 306 (which in this case has been deemed to be a risk path), while still allowing speculation along the “Not Taken” code pathway 302.

Exemplary instruction code for use with example 310 is as follows, which instead uses a BGENST instruction (an asymmetric conditional branch instruction):

| | |
|---|---|
| CMP X1, #value | ; |
| BGENST over | ; Branch Greater Than or Equal, No |

Speculation along Taken Branch

LSL X1, X1, #8
B end

Over

| | |
|---|---|
| LDR X1, [X2] | ; speculative side-channel risk |
| LSL X1, X1, #4 | ; |
| LDR X3, [X1] | ; |

end

LSL X1, X1 #8
...

BGENST is an asymmetric conditional branch instruction that blocks speculation down the “Taken” code path, thus avoiding the risky pathway 306, while still allowing speculation to proceed down the “Taken” path 302 if the branch predictor predicts that pathway.

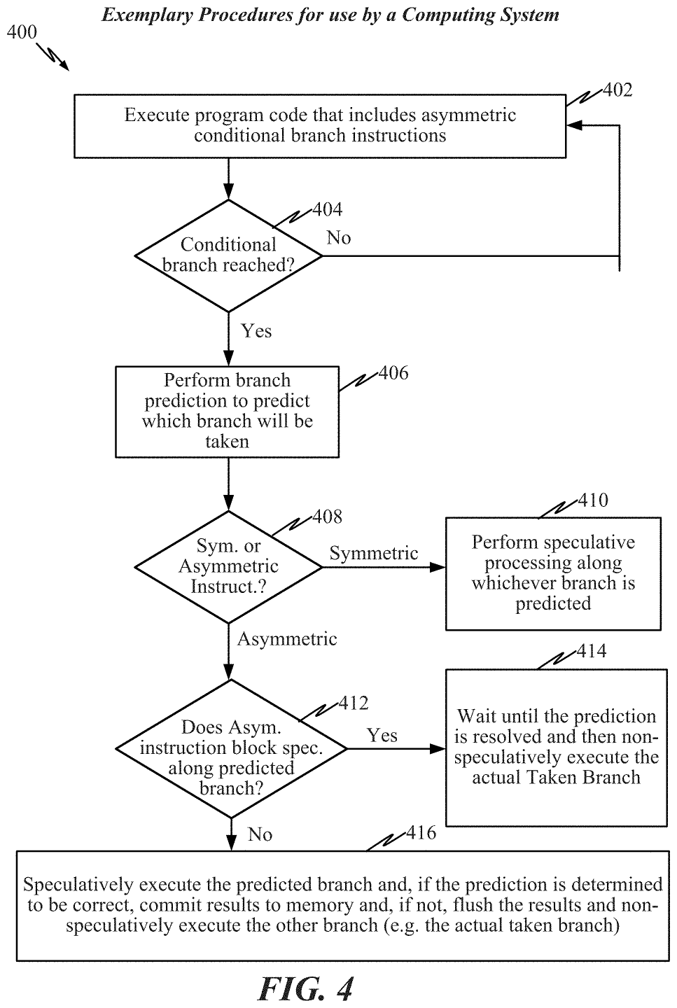

FIG. 4 illustrates exemplary processing features within a flowchart 400. Beginning at 402, a computing system executes program code that includes asymmetric conditional branch instructions. If a branch is reached, as indicated at decision block 404, a branch prediction is made at block 406 to predict which branch will be taken. If the branch instruction corresponding to the conditional branch is a (standard) symmetric branch instruction, as determined at decision block 408, then the computing system performs speculative execution, at 410, along whichever branch is predicted. That is, speculation is allowed along either branch (since neither branch has been deemed risky).

However, if the instruction is an asymmetric conditional branch instruction, and the asymmetric instruction blocks speculation along the predicted branch, as indicated at decision block 412, then the computing system, at block 414, waits until the prediction is resolved and then non-speculatively executes the branch actually taken. If the asymmetric instruction does not block speculation along the predicted branch, the computing system, at block 416, speculatively executes the predicted branch and, if the prediction is determined to be correct, commits the results to memory and, if not, flushes the results and non-speculatively executes the other branch (e.g. the actual taken branch).

As noted above, asymmetric instructions may apply to Taken Branches or Not Taken branches, and so, in some cases, the computing system might speculate along the Not Taken branch rather than along the Taken Branch, depending upon the programming.

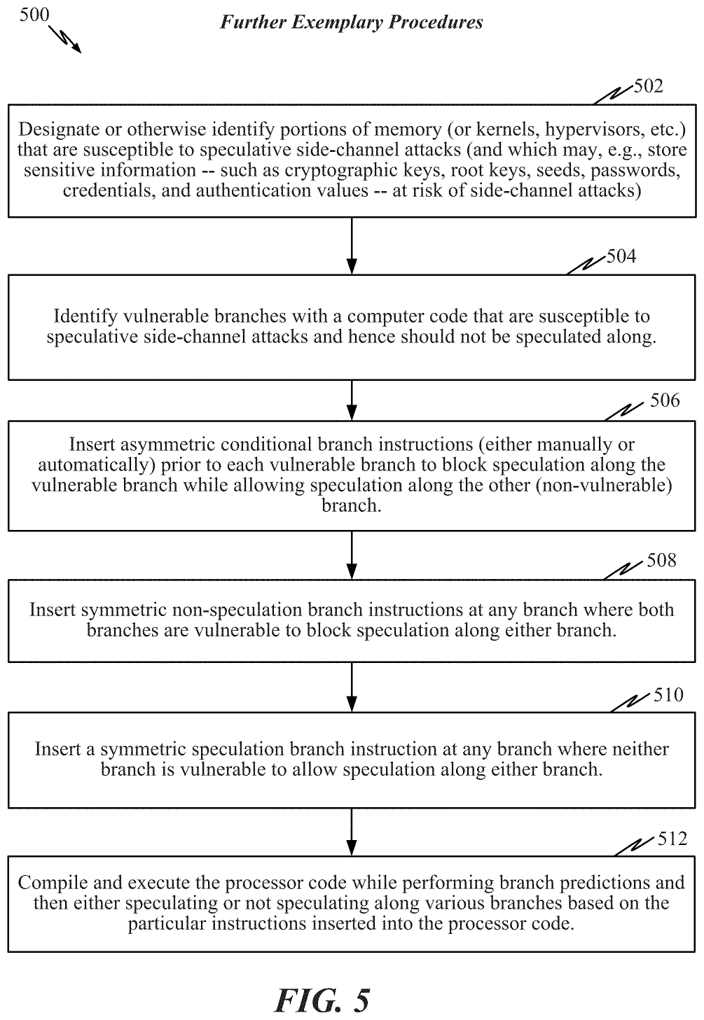

FIG. 5 illustrates exemplary procedures within a flowchart 500 for generating processor code that includes asymmetric conditional branch instructions. Beginning at 502, portions of memory (or kernels, hypervisors, etc.) that are susceptible or vulnerable to speculative side-channel attacks (and which may, e.g., store sensitive information at risk of speculative side-channel attacks) are designated or otherwise identified. Sensitive information may include, for example, cryptographic keys, root keys, seeds, passwords, credentials, and authentication values. At 504, vulnerable branches that are susceptible to a speculative side-channel attack are identified within a computer code. These vulnerable branches should not be speculated along. The identification or designation of any portions of memory vulnerable to attacks or any vulnerable branches may be performed by human programmers or engineers or by a suitably-equipped automated system such as a compiler based on the details of the particular processing system.

Notably, although the procedures described herein are provided to, inter alia, protect sensitive information, there is no need to identify any particular information that needs to be protected. That is, there is no need to identify any specific secrets in memory, or their particular locations. Rather, in the example of FIG. 5 and in other examples described herein, it is sufficient to identify branches that are susceptible or vulnerable to speculative side-channel attacks, without identifying the particular data that might be vulnerable to those attacks. The identification or designation of susceptible branches (or portions of memory those branches access) may be performed by human designers, programmers or engineers (e.g. manually) or by a suitably-equipped automated system such as a compiler (e.g. automatically). In this regard, within a particular processor design, such as a processor for use in the system-on-a-chip (SoC) of a smartphone, the memory that stores passwords and credentials is often designated as a secure memory. That memory, and any processing branches leading to that memory, may be known in advance to be susceptible to side-channel attacks based on known attacks and based, for example, on physical side-channel signals known to be emitted by the device during its operation. A compiler thus may be programmed to identify secure memory and/or identify vulnerable code branches that access such memory. In this manner, a processing branch having an instruction that explicitly reads data from secure memory that is known to be vulnerable to side-channel attacks be may be readily identified by a compiler as a branch that is susceptible to a speculative side-channel attack and should not be speculated along.

At 506, asymmetric conditional branch instructions are inserted prior to each vulnerable/susceptible branch to thereby block speculation along the vulnerable branch while allowing speculation along the other (non-vulnerable) branch. The insertion of the asymmetric conditional branch instruction may be performed by human programmers or engineers while writing or designing the code or by a suitably-equipped automated system such as a compiler that compiles programming code into a sequence of instructions.

At 508, symmetric non-speculation branch instructions are inserted at any branch where both branches are vulnerable to block speculation along both branches. As with the asymmetric instructions, the symmetric instructions may be inserted by human programmers or engineers while writing or designing the code or by a suitably-equipped automated system such as a compiler.

At 510, symmetric speculation branch instructions are inserted at any branch where neither branch is vulnerable to allow speculation along either branch. Again, such instructions may be inserted by human programmers or engineers while writing or designing the code or by a suitably-equipped automated system such as a compiler.

At 512, the processor code is compiled and executed while performing branch predictions and then either speculating or not speculating along various branches based on the particular instructions that have been inserted into the processor code.

### Exemplary Hardware Environments

Aspects of the systems and methods described herein can be exploited using a wide variety of computing systems and for a wide range of applications, including mobile devices, servers, etc. To provide a concrete example of a computing system, an exemplary system will now be described that uses a RISC-based CPU.

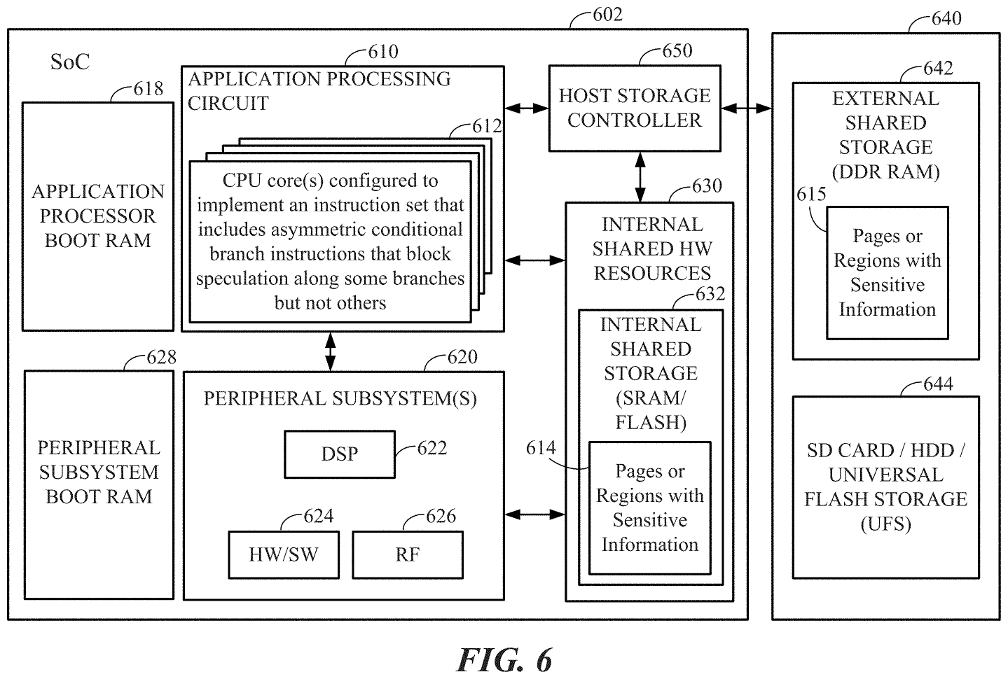

FIG. 6 illustrates selected components of a computing system 600 having a SoC processing circuit 602. The SoC processing circuit 602 may be a modified version of a Snapdragon™ processing circuit of Qualcomm Incorporated for use within a mobile device user equipment (UE) or in other devices or systems. The SoC processing circuit 602 includes an application processing circuit 610, which includes a multi-core CPU 612 configured to implement an instruction set that includes asymmetric conditional branch instructions that block speculation along some conditional processing code branches but not others. In the example of FIG. 6, the asymmetric conditional branch instructions are used to block speculation along processor code branches that access pages or regions 614 and/or 615 with sensitive information, which may be maintained, e.g. within an internal shared storage device 632 (e.g. SRAM or flash memory) of internal shared storage HW resources 632 and/or within an external shared storage (e.g. DDR RAM) 642. However, as discussed above, speculation may be blocked along any branch that might subject the system to side-channel attacks or other attacks by hackers or other malicious entities.

In the example of FIG. 6, the application processing circuit 610 is coupled to a host storage controller 650 for controlling storage of data in the internal shared storage device 632 that forms part of internal shared hardware HW resources 630. The application processing circuit 610 may also include a boot RAM or ROM 618 that stores boot sequence instructions for the various components of the SoC processing circuit 602. The SoC processing circuit 602 further includes one or more peripheral subsystems 620 controlled by application processing circuit 610. The peripheral subsystems 620 may include but are not limited to a storage subsystem (e.g., read-only memory (ROM)/RAM), a video/graphics subsystem (e.g., digital signal processing circuit (DSP), graphics processing circuit unit (GPU)), an audio subsystem (e.g., DSP, analog-to-digital converter (ADC), digital-to-analog converter (DAC)), a power management subsystem, security subsystem (e.g., encryption components/digital rights management (DRM) components), an input/output (I/O) subsystem (e.g., keyboard, touchscreen) and wired and wireless connectivity subsystems (e.g., universal serial bus (USB), Global Positioning System (GPS), Wi-Fi, Global System Mobile (GSM), Code Division Multiple Access (CDMA), 4G Long Term Evolution (LTE) modems). The exemplary peripheral subsystem 620, which is a modem subsystem, includes a DSP 622, various other hardware (HW) and software (SW) components 624, and various radio-frequency (RF) components 626.

In one aspect, each peripheral subsystem 620 also includes a boot RAM or ROM 628 that stores a primary boot image (not shown) of the associated peripheral subsystems 620. As noted, the SoC processing circuit 602 further includes various internal shared HW resources 630, such as the aforementioned internal shared storage 632 (e.g. SRAM), which is shared by the application processing circuit 610 and the various peripheral subsystems 620 to store various runtime data or other parameters and to provide host memory and which may store various keys or passwords for secure processing.

In one aspect, the components 610, 618, 620, 628, 630 and 650 of the SoC 602 are integrated on a single-chip substrate. The system further includes various external shared HW resources 640, which may be located on a different chip substrate and may communicate with the SoC 602 via one or more buses. External shared HW resources 640 may include, for example, the aforementioned external shared storage 642 (e.g. double-data rate (DDR) DRAM), which may include pages 615 of sensitive information, and/or permanent or semi-permanent data storage 644 (e.g., a secure digital (SD) card, hard disk drive (HDD), an embedded multimedia card, a universal flash device (UFS), etc.), which may be shared by the application processing circuit 610 and the various peripheral subsystems 620 to store various types of data, such as an operating system (OS) information, system files, programs, applications, user data, audio/video files, etc. When a device incorporating the SoC 602 is activated, the SoC 602 begins a system boot up process in which the application processing circuit 610 may access boot RAM or ROM 618 to retrieve boot instructions for the SoC processing circuit 602, including boot sequence instructions for the various peripheral subsystems 620. The peripheral subsystems 620 may also have additional peripheral boot RAM or ROM 628.

In some examples, sensitive data may be stored off chip, such as in DDR RAM 642

### Further Exemplary Embodiments and Environments

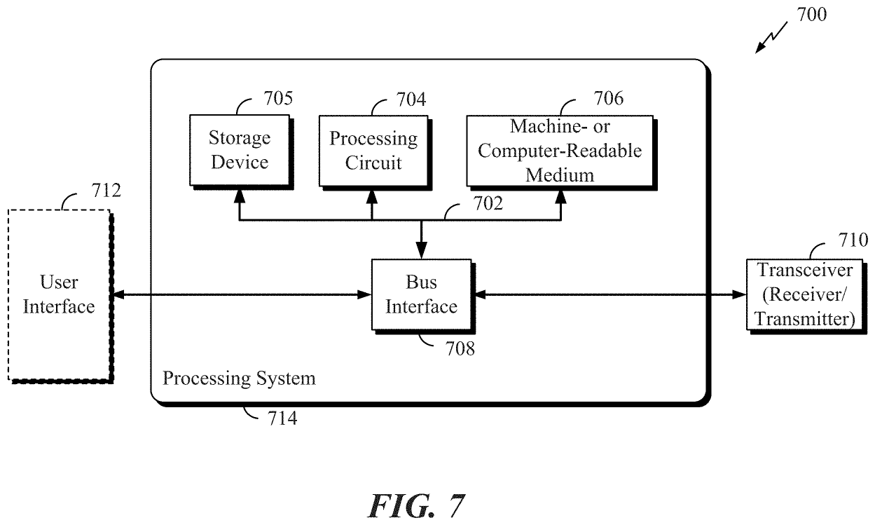

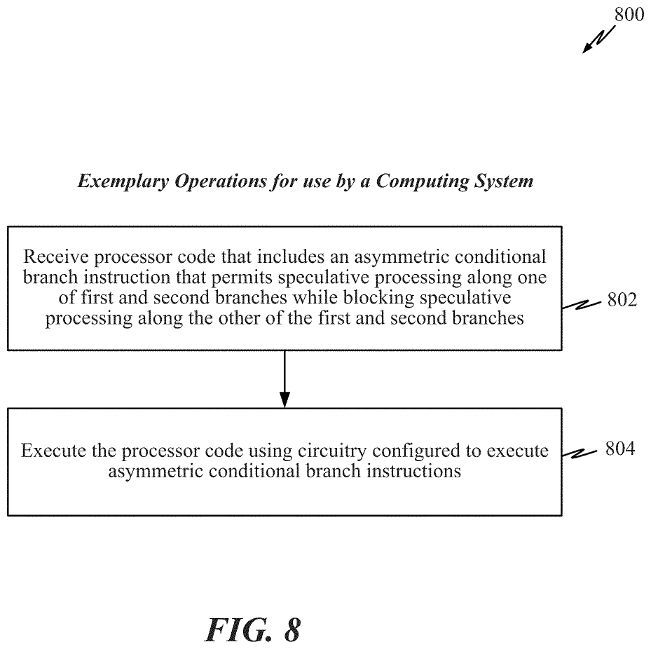

FIG. 7 illustrates an overall system or apparatus 700 in which the systems, methods and apparatus of FIGS. 1-6 (and FIGS. 8-14, discussed below) may be implemented. In accordance with various aspects of the disclosure, an element, or any portion of an element, or any combination of elements may be implemented with a processing system 714 that includes one or more processing circuits 704, such as the SoC of FIG. 6. Depending upon the device, apparatus 700 may be used with a radio network controller (RNC).

In the example of FIG. 7, the processing system 714 may be implemented with a bus architecture, represented generally by bus 702. The bus 702 may include any number of interconnecting buses and bridges depending on the specific application of the processing system 714 and the overall design constraints. The bus 702 links various circuits including one or more processing circuits (represented generally by the processing circuit 704), the storage device 705, and a machine-readable, processor-readable, processing circuit-readable or computer-readable media (represented generally by a non-transitory machine-readable medium 706) The bus 702 may also link various other circuits such as timing sources, peripherals, voltage regulators, and power management circuits, which are well known in the art, and therefore, will not be described any further. The bus interface 708 provides an interface between bus 702 and a transceiver 710. The transceiver 710 provides a means for communicating with various other apparatus over a transmission medium. Depending upon the nature of the apparatus, a user interface 712 (e.g., keypad, display, speaker, microphone, joystick) may also be provided but is not required.

The processing circuit 704 is responsible for managing the bus 702 and for general processing, including the execution of software stored on the machine-readable medium 706. The software, when executed by processing circuit 704, causes processing system 714 to perform the various functions described herein for any particular apparatus. Machine-readable medium 706 may also be used for storing data that is manipulated by processing circuit 704 when executing software.

One or more processing circuits 704 in the processing system may execute software or software components. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A processing circuit may perform the tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc. may be passed, forwarded, or transmitted via any suitable means including memory sharing, message passing, token passing, network transmission, etc.

The software may reside on machine-readable medium 706. The machine-readable medium 706 may be a non-transitory machine-readable medium or computer-readable medium. A non-transitory processing circuit-readable, machine-readable or computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), RAM, ROM, a programmable ROM (PROM), an erasable PROM (EPROM), an electrically erasable PROM (EEPROM), a register, a removable disk, a hard disk, a CD-ROM and any other suitable medium for storing software and/or instructions that may be accessed and read by a machine or computer. The terms “machine-readable medium”, “computer-readable medium”, “processing circuit-readable medium” and/or “processor-readable medium” may include, but are not limited to, non-transitory media such as portable or fixed storage devices, optical storage devices, and various other media capable of storing, containing or carrying instruction(s) and/or data. Thus, the various methods described herein may be fully or partially implemented by instructions and/or data that may be stored in a “machine-readable medium,” “computer-readable medium,” “processing circuit-readable medium” and/or “processor-readable medium” and executed by one or more processing circuits, machines and/or devices. The machine-readable medium may also include, by way of example, a carrier wave, a transmission line, and any other suitable medium for transmitting software and/or instructions that may be accessed and read by a computer.

The machine-readable medium 706 may reside in the processing system 714, external to the processing system 714, or distributed across multiple entities including the processing system 714. The machine-readable medium 706 may be embodied in a computer program product. By way of example, a computer program product may include a machine-readable medium in packaging materials. Those skilled in the art will recognize how best to implement the described functionality presented throughout this disclosure depending on the particular application and the overall design constraints imposed on the overall system.

The various illustrative logical blocks, modules, circuits, elements, and/or components described in connection with the examples disclosed herein may be implemented or performed with a general purpose processing circuit, a DSP, an application specific integrated circuit (ASIC), a field programmable gate array (FPGA) or other programmable logic component, discrete gate or transistor logic, discrete hardware components, or any combination thereof designed to perform the functions described herein. A general purpose processing circuit may be a microprocessing circuit, but in the alternative, the processing circuit may be any conventional processing circuit, controller, microcontroller, or state machine. A processing circuit may also be implemented as a combination of computing components, e.g., a combination of a DSP and a microprocessing circuit, a number of microprocessing circuits, one or more microprocessing circuits in conjunction with a DSP core, or any other such configuration.

Hence, in one aspect of the disclosure, processing circuit 704 illustrated in FIG. 7—or components thereof—may be a specialized processing circuit (e.g., an ASIC)) that is specifically designed and/or hard-wired to perform the algorithms, methods, and/or blocks described in FIGS. 1, 2, 3, 4, 5, and 6 (and in FIGS. 8, 9, 10, 11, 12, 13, 14 and 15, discussed below). Thus, such a specialized processing circuit (e.g., ASIC) may be one example of a means for executing the algorithms, methods, and/or blocks described in FIGS. 1, 2, 3, 4, 5, and 6 (and in FIGS. 8, 9, 10, 11, 12, 13, 14 and 15, discussed below). The machine-readable storage medium may store instructions that when executed by a specialized processing circuit (e.g., ASIC) cause the specialized processing circuit to perform the algorithms, methods, and/or blocks described herein.

FIG. 8 illustrates an exemplary method 800 that may be provided for use by a computing system or processor having circuitry configured for the speculative execution of processor code. Briefly, at 802, processor code is input or received that includes an asymmetric conditional branch instruction (e.g. at least one such instruction) that permits speculative execution along one of first and second branches while blocking speculative execution along the other of the first and second branches. At 804, the processor code is executed using circuitry of the processor configured to execute asymmetric conditional branch instructions. As explained above, the execution of an asymmetric conditional branch instruction may include speculatively executing code following the asymmetric conditional branch instruction along one of the first and second branches using the circuitry configured for speculative execution, and non-speculatively executing code following the asymmetric conditional branch instruction along the other of the first and second branches using circuitry of the processor configured for non-speculative execution. Examples of these general procedures, and the systems and components that implement the procedures, are described above with reference to FIGS. 1-6.

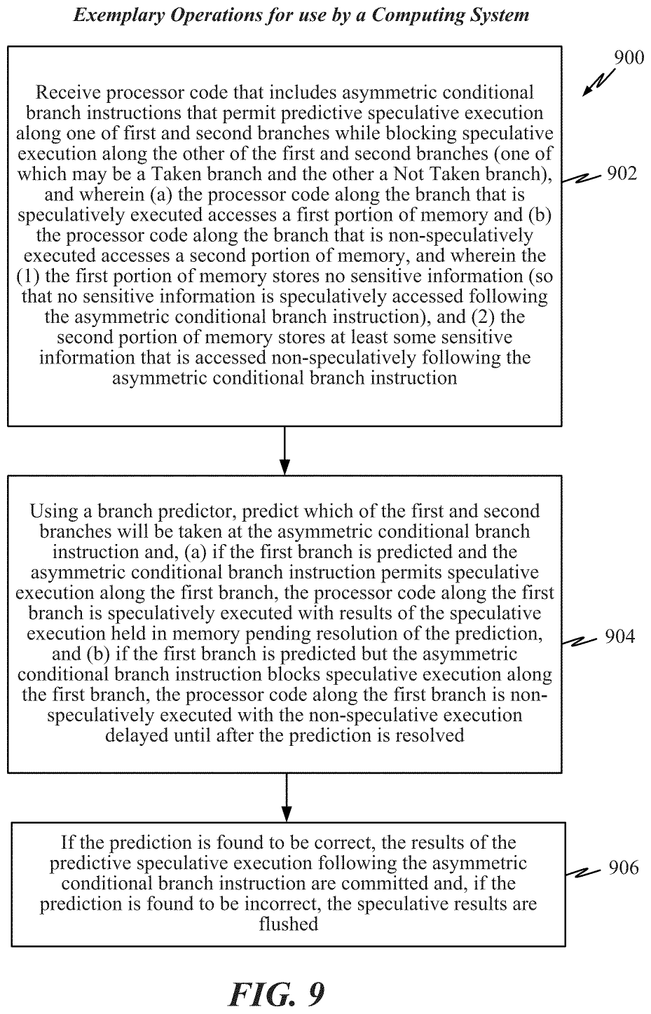

FIG. 9 summarizes additional features via an exemplary method 900. At 902, processor code is received by the computing system where the code includes asymmetric conditional branch instructions that permit predictive speculative execution along one of first and second branches while blocking speculative execution along the other of the first and second branches (one of which may be a Taken branch and the other a Not Taken branch), wherein (a) the processor code along the branch that is speculatively executed accesses a first portion of memory and (b) the processor code along the branch that is non-speculatively executed accesses a second portion of memory, and further wherein (1) the first portion of memory stores no sensitive information (so that no sensitive information is speculatively accessed following the asymmetric conditional branch instruction), and the (2) the second portion of memory stores at least some sensitive information that is accessed non-speculatively following the asymmetric conditional branch instruction.

At 904, using a branch predictor, the system predicts which of the first and second branches will be taken at the asymmetric conditional branch instruction and, (a) if the first branch is predicted and the asymmetric conditional branch instruction permits speculative execution along the first branch, the processor code along the first branch is speculatively executed with results of the speculative execution held in memory pending resolution of the prediction, and (b) if the first branch is predicted but the asymmetric conditional branch instruction blocks speculative execution along the first branch, the processor code along the first branch is non-speculatively executed with the non-speculative execution delayed until after the prediction is resolved. At 906, if the prediction is found to be correct by the system, the results of the predictive speculative execution following the asymmetric conditional branch instruction are committed and, if the prediction is found to be incorrect, the speculative results are flushed.

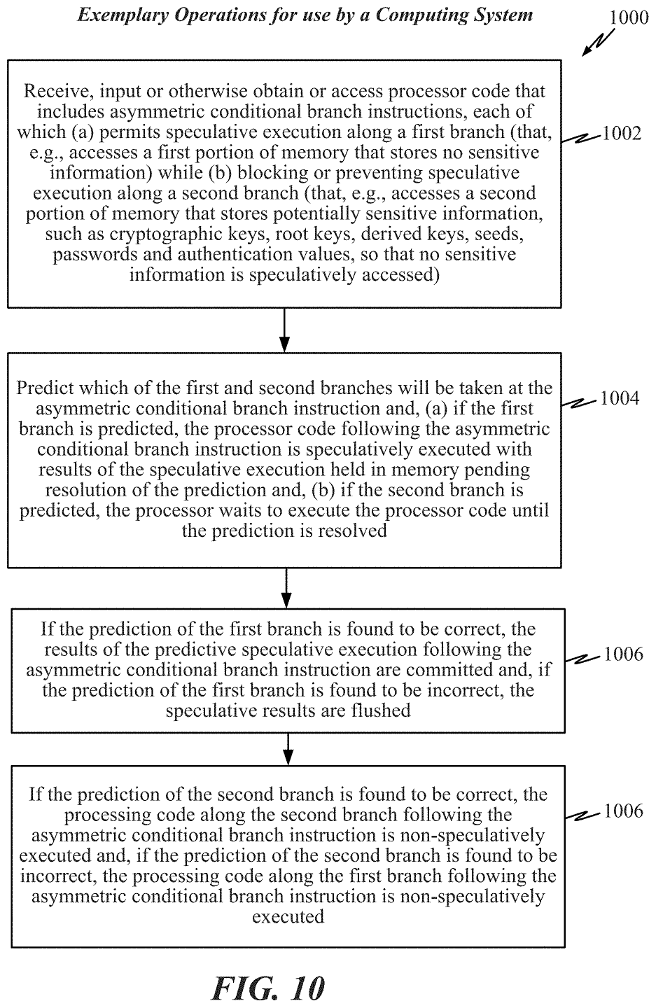

FIG. 10 summarizes still other features via an exemplary method 1000. At 1002, the computing system receives, inputs or otherwise obtains or accesses processor code that includes asymmetric conditional branch instructions, each of which (a) permits speculative execution along a first branch (that, e.g., accesses a first portion of memory that stores no sensitive information) while (b) blocking or preventing speculative execution along a second branch (that, e.g., accesses a second portion of memory that stores potentially sensitive information, such as cryptographic keys, root keys, derived keys, seeds, passwords and authentication values, so that no sensitive information is speculatively accessed). At 1004, using a branch predictor or the like, the computing system predicts which of the first and second branches will be taken at the asymmetric conditional branch instruction and, (a) if the first branch is predicted, the processor code following the asymmetric conditional branch instruction is speculatively executed with results of the speculative execution held in memory pending resolution of the prediction and, (b) if the second branch is predicted, the processor waits to execute the processor code until the prediction is resolved.

At 1006, if the prediction of the first branch is found to be correct by the computing system, the results of the predictive speculative execution following the asymmetric conditional branch instruction are committed and, if the prediction of the first branch is found to be incorrect, the speculative results are flushed. At 1008, if the prediction of the second branch is found to be correct by the computing system, the processing code along the second branch following the asymmetric conditional branch instruction is non-speculatively executed and, if the prediction of the second branch is found to be incorrect, the processing code along the first branch following the asymmetric conditional branch instruction is non-speculatively executed.

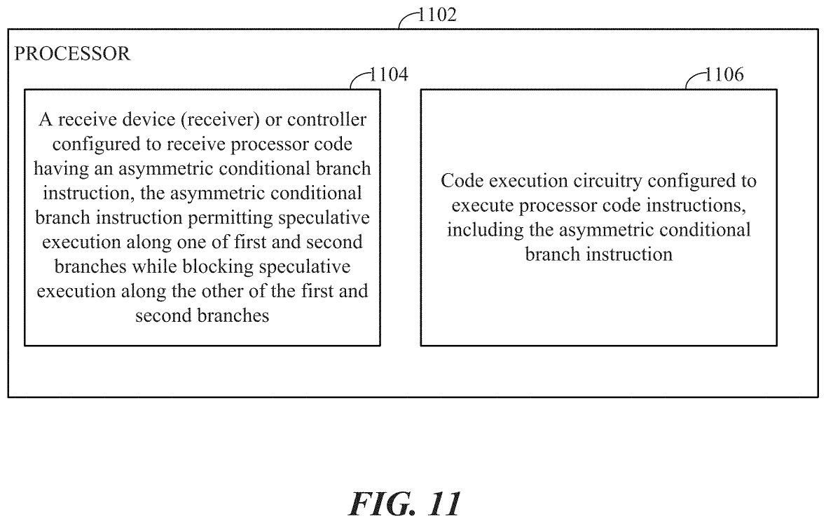

FIG. 11 illustrates components of an exemplary computing system or processing system 1100 having a processor 1102. The processor 1102 includes an input or receive device (receiver) or controller 1104 configured to receive processor code having an asymmetric conditional branch instruction, the asymmetric conditional branch instruction permitting speculative execution along one of first and second branches while blocking speculative execution along the other of the first and second branches. The processor 1102 also includes code execution circuitry 1106 configured to execute processor code instructions, including the asymmetric conditional branch instruction.

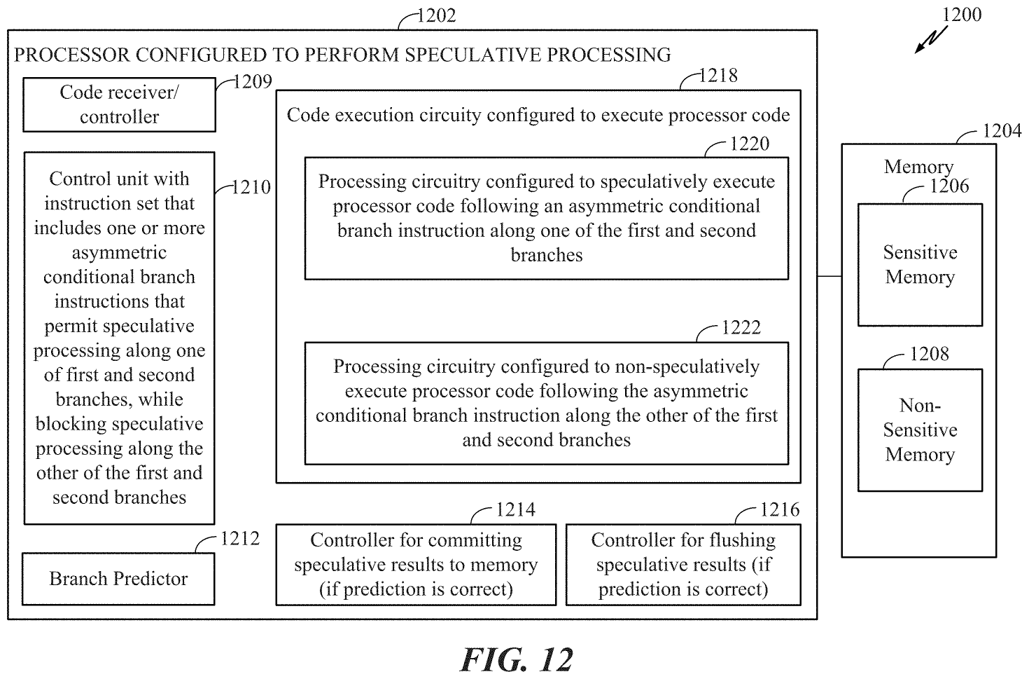

FIG. 12 illustrates components of another exemplary computing system or processing system 1200 having a processor 1202 configured to perform speculative execution. The computing system 1200 also includes a memory 1204 that includes a sensitive memory portion 1206 (for storing cryptographic keys and the like) and a non-sensitive memory portion 1208 (for storing other data that is not deemed sensitive). The processor 1202 includes a code receiver/controller 1209 configured for receiving processor code that includes an asymmetric conditional branch instruction that permits speculative execution along one of first and second branches while blocking speculative execution along the other of the first and second branches. (The processor code may be received or input from the memory 1204, if it is stored there, or from another source.)

The processor 1202 also includes a control unit 1210 configured with an instruction set that includes one or more asymmetric conditional branch instructions that permit speculative execution along one of first and second branches, while blocking speculative execution along the other of the first and second branches. As noted above, there are many ways to implement an instruction set architecture within a processing system, such as by hardwiring the functions of the instructions into the processor, using microcode, etc. A control unit of the type shown in FIG. 12 may not be needed in some implementations. The processor 1202 includes a branch predictor 1212, a controller 1214 for committing speculative results to memory (if the prediction is correct), and a controller 1218 for flushing speculative results (if the prediction is correct).

The processor 1202 includes code execution circuitry 1218 that is configured to execute processor code. The code execution circuitry 1218 includes, in this example, processing circuitry 1220 configured to speculatively execute processor code following a asymmetric conditional branch instruction along one of the first and second branches, and processing circuitry 1222 configured to non-speculatively execute processor code following the asymmetric conditional branch instruction along the other of the first and second branches. The speculating processing circuitry 1220 and the non-speculating processing circuitry 1220 are shown separately in FIG. 12 to highlight their different functions, but it should be understood that physically separate circuitry need not be employed. Rather, a single processor or single set of processing circuits may be configured to perform both the speculative and non-speculative execution.

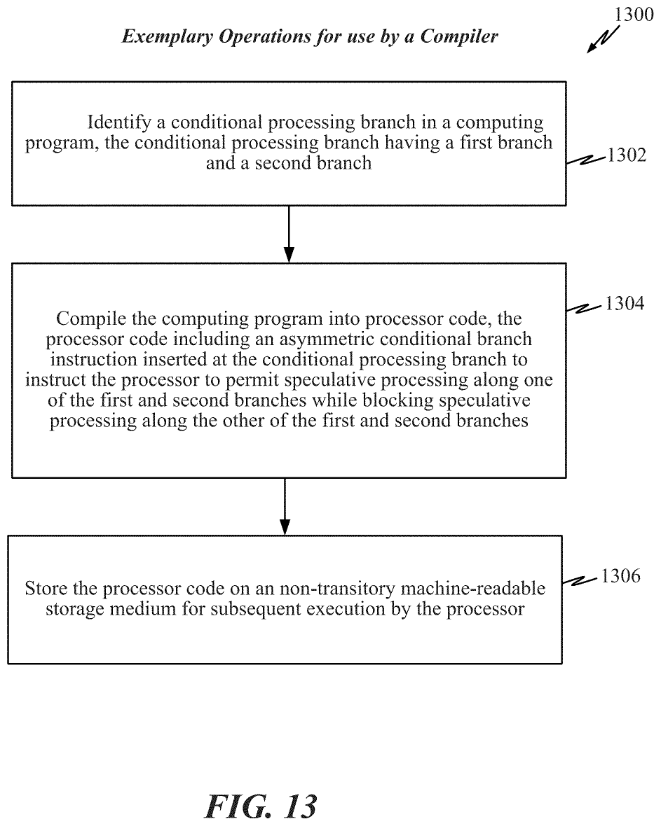

FIG. 13 illustrates an exemplary method 1300 that may be provided for use by a compiler or other device or system for converting a computing program to processor code for executing on a processor configured to perform speculative execution. Briefly, at 1302, the compiler identifies a conditional processing branch in a computing program, the conditional processing branch having a first branch and a second branch. At 1304, the compiler compiles the computing program into processor code, the processor code including an asymmetric conditional branch instruction inserted at the conditional processing branch to instruct the processor to permit speculative execution along one of the first and second branches while blocking speculative execution along the other of the first and second branches. At 1306, the compiler stores the processor code on a non-transitory machine-readable storage medium for subsequent execution by the processor.

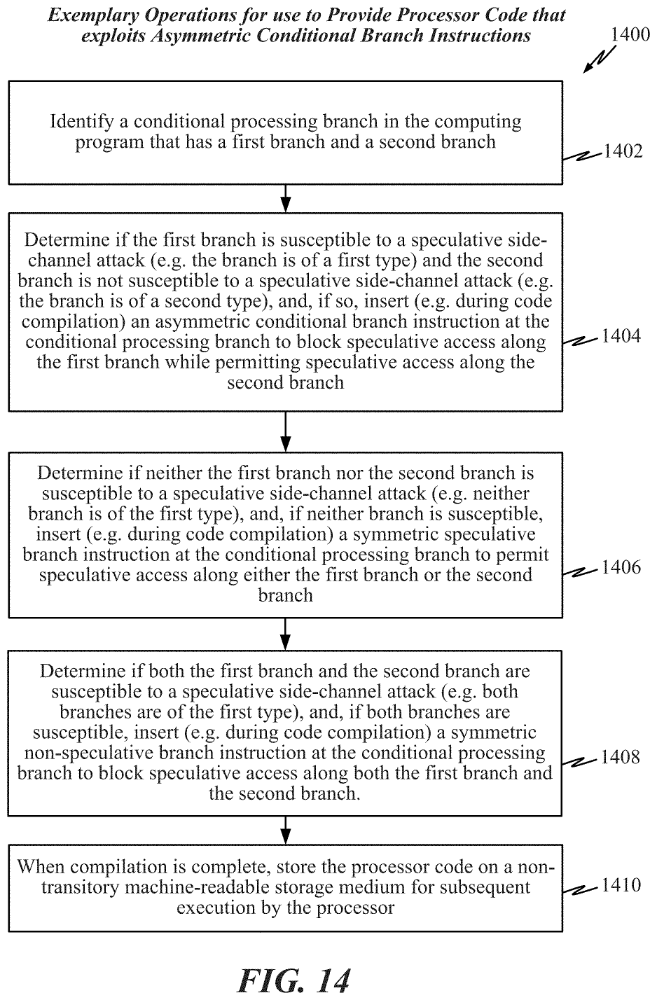

FIG. 14 summarizes additional features via an exemplary method 1400 for providing and compiling processor code that uses asymmetric conditional branch instructions will now be summarized. At 1402, a conditional processing branch is identified in the computing program that has a first branch and a second branch. The identification of conditional processing branches in a computing program may be performed by human designers or engineers (such as by the individuals writing the computer program) or by a suitably-equipped automated system such as a compiler.

At 1404, the automated compiler (or, e.g., the code designer) determines if the first branch is susceptible to a speculative side-channel attack (e.g. the branch is of a first type) and the second branch is not susceptible to a speculative side-channel attack (e.g. the branch is of a second type), and, if so, inserts (e.g. during code compilation) an asymmetric conditional branch instruction at the conditional processing branch to block speculative access along the first branch while permitting speculative access along the second branch. At 1406, the automated compiler (or, e.g., a code designer) determines if neither the first branch nor the second branch is susceptible to a speculative side-channel attack (e.g. neither branch is of the first type and both branches are of the second type), and, if neither branch is susceptible, inserts (e.g. during code compilation) a symmetric speculative branch instruction at the conditional processing branch to permit speculative access along either the first branch or the second branch. At 1408, the automated compiler (or, e.g., the code designer) determines if both the first branch and the second branch are susceptible to speculative side-channel attacks (e.g. both branches are of a first type), and, if both branches are susceptible, inserts (e.g. during code compilation) a symmetric non-speculative branch instruction at the conditional processing branch to block speculative access along both the first branch and the second branch. At 1410, when compilation is complete (or the computing program is otherwise converted to machine-readable code), the processor code is stored on a non-transitory machine-readable storage medium for subsequent execution by the processor.

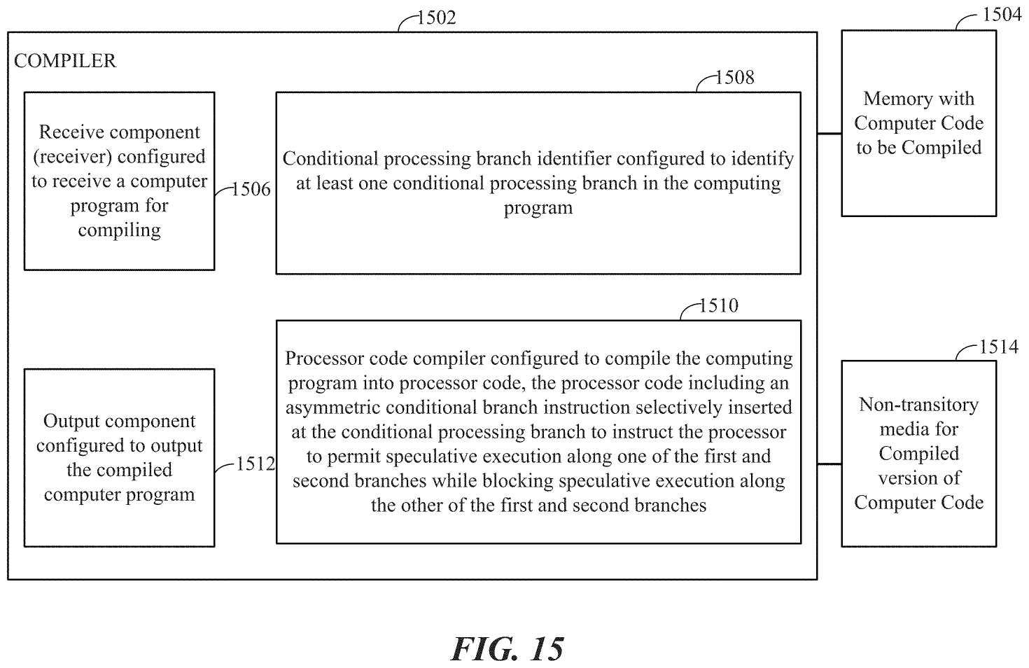

FIG. 15 illustrates components of an exemplary compiler 1502 configured to compile computer code 1504 (stored in a memory) into machine code that includes at least some asymmetric conditional branch instructions. The compiler 1502 includes a receive component (receiver) 1506 configured to receive a computer program for compiling. The compiler 1502 also includes a conditional processing branch identifier 1508 configured to identify at least one conditional processing branch in the computing program based, e.g., on whether the branch accesses a portion of the memory space storing sensitive information. The compiler 1502 also includes a processor code compiler 1510 configured to compile the computing program into processor code (such as machine language code), the processor code including at least one asymmetric conditional branch instruction selectively inserted at the conditional processing branch to instruct the processor to permit speculative execution along one of the first and second branches while blocking speculative execution along the other of the first and second branches. An output component 1512 is configured to output the compiled computer program to a non-transitory media 1514 for subsequent execution by a suitably-equipped processor.

In at least some examples, means may be provided for performing the functions illustrated in the various figures and/or other functions described herein. For example, an apparatus (e.g. processor 1202 of FIG. 12) may be provided where the apparatus includes: means (e.g. component 1209) for receiving processor code that includes an asymmetric conditional branch instruction that permits speculative execution along one of first and second branches while blocking speculative execution along the other of the first and second branches. The apparatus may include means (e.g. code execution circuitry 1218) for executing the processor code using circuitry of the processor configured to execute asymmetric conditional branch instructions. The means for executing may include means (e.g. circuitry 1220) for speculatively executing code following the asymmetric conditional branch instruction along one of the first and second branches using the circuitry configured for speculative execution, and means (e.g. circuitry 1222) for non-speculatively executing code following the asymmetric conditional branch instruction along the other of the first and second branches using circuitry of the processor configured for non-speculative execution. The processor code along the branch that is speculatively executed may access a first portion of memory (e.g. non-sensitive memory 1208), whereas the processor code along the branch that is non-speculatively executed may access a second portion of memory (e.g. sensitive memory 1206). In illustrative examples, the first portion of memory stores no sensitive information so no sensitive information is speculatively accessed by the circuitry configured for speculative execution following the asymmetric conditional branch instruction. The second portion of memory may store at least some sensitive information that is accessed non-speculatively following the asymmetric conditional branch instruction.

The apparatus may also include means (e.g. branch predictor 1212) for predicting which one of the first and second branches will be taken at the asymmetric conditional branch instruction. If the first branch is predicted and the asymmetric conditional branch instruction permits speculative execution along the first branch, the means for executing the processor code along the first branch executes the code speculatively with results of the speculative execution held in memory pending resolution of the prediction. If the first branch is predicted but the asymmetric conditional branch instruction blocks speculative execution along the first branch, the means for executing the processor code along the first branch executes the code non-speculatively, with the non-speculative execution delayed until after the prediction is resolved. The apparatus may include means (e.g. controller 1214) for committing speculative results to memory (if the prediction is correct) and means (e.g. controller 1216) for flushing speculative results (if the prediction is not correct).

As another example, an apparatus (e.g. compiler 1502 of FIG. 15) may be provided where the apparatus includes: means (e.g. receiver 1506) for receiving a computer program for compiling; and means (e.g. conditional processing branch identifier 1508) for identifying a conditional processing branch in the computing program, the conditional processing branch having a first branch and a second branch. The apparatus may also include: means (e.g. processor code compiler 1510) for compiling the computing program into processor code, the processor code including an asymmetric conditional branch instruction selectively inserted at the conditional processing branch to instruct the processor to permit speculative execution along one of the first and second branches while blocking speculative execution along the other of the first and second branches; and means (e.g. output component 1512) for storing the processor code on an non-transitory machine-readable storage medium (such as media 1514) for subsequent execution by a suitably-equipped processor. These are just some exemplary means plus function components.

In at least some examples, a machine-readable storage medium may be provided having one or more instructions which when executed by a processing circuit causes the processing circuit to performing the functions illustrated in the figures and/or other functions described herein. For example, instructions may be provided for: receiving processor code that includes an asymmetric conditional branch instruction that permits speculative execution along one of first and second branches while blocking speculative execution along the other of the first and second branches. The instructions may include instructions for executing the processor code using circuitry of the processor configured to execute asymmetric conditional branch instructions. The instructions may include instructions for speculatively executing code following the asymmetric conditional branch instruction along one of the first and second branches using the circuitry configured for speculative execution, and instructions for non-speculatively executing code following the asymmetric conditional branch instruction along the other of the first and second branches using circuitry of the processor configured for non-speculative execution.

The instructions may also include instructions for predicting which one of the first and second branches will be taken at the asymmetric conditional branch instruction. If the first branch is predicted and the asymmetric conditional branch instruction permits speculative execution along the first branch, the instructions for executing the processor code along the first branch executes the code speculatively with results of the speculative execution held in memory pending resolution of the prediction. If the first branch is predicted but the asymmetric conditional branch instruction blocks speculative execution along the first branch, the instructions for executing the processor code along the first branch executes the code non-speculatively, with the non-speculative execution delayed until after the prediction is resolved. The instructions may include instructions for committing speculative results to memory (if the prediction is correct) and instructions for flushing speculative results (if the prediction is not correct).

As another example, instructions may be provided where the instructions includes: instructions for receiving a computer program for compiling; and instructions for identifying a conditional processing branch in the computing program, the conditional processing branch having a first branch and a second branch. The instructions may also include: instructions for compiling the computing program into processor code, the processor code including an asymmetric conditional branch instruction selectively inserted at the conditional processing branch to instruct the processor to permit speculative execution along one of the first and second branches while blocking speculative execution along the other of the first and second branches; and instructions for storing the processor code on an non-transitory machine-readable storage medium for subsequent execution by a suitably-equipped processor. These are just some exemplary instructions.

Note that, herein, the terms “obtain” or “obtaining” broadly cover, e.g., calculating, computing, generating, acquiring, receiving, retrieving, inputting or performing any other suitable corresponding actions. Note also that aspects of the present disclosure may be described herein as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

The various features described herein can be implemented in different systems without departing from the disclosure. It should be noted that the foregoing embodiments are merely examples and are not to be construed as limiting the disclosure. The description of the embodiments is intended to be illustrative, and not to limit the scope of the claims. As such, the present teachings can be readily applied to other types of apparatuses and many alternatives, modifications, and variations will be apparent to those skilled in the art.

Moreover, in the following description and claims the terms “coupled” and “connected,” along with their derivatives, may be used. It should be understood that these terms are not intended as synonyms for each other. Rather, in particular aspects, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An aspect is an implementation or example. Reference in the specification to “an aspect,” “one aspect,” “some aspects,” “various aspects,” or “other aspects” means that a particular feature, structure, or characteristic described in connection with the aspects is included in at least some aspects, but not necessarily all aspects, of the present techniques. The various appearances of “an aspect,” “one aspect,” or “some aspects” are not necessarily all referring to the same aspects. Elements or aspects from an aspect can be combined with elements or aspects of another aspect.

Not all components, features, structures, characteristics, etc. described and illustrated herein need be included in a particular aspect or aspects. If the specification states a component, feature, structure, or characteristic “may,” “might,” “can” or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

In each figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

It is to be noted that, although some aspects have been described in reference to particular implementations, other implementations are possible according to some aspects. Additionally, the arrangement and/or order of circuit elements or other features illustrated in the drawings and/or described herein need not be arranged as illustrated and described. Many other arrangements are possible according to some aspects.

What is claimed is:

1. A method for use by a processor, the method comprising:
receiving processor code that includes an asymmetric conditional branch instruction that permits speculative execution along one of first and second branches while blocking speculative execution along the other of the first and second branches; and
executing the processor code using circuitry of the processor configured to execute asymmetric conditional branch instructions.

2. The method of claim 1, wherein executing the processor code comprises:
speculatively executing code following the asymmetric conditional branch instruction along one of the first and second branches using circuitry configured for speculative execution; and
non-speculatively executing code following the asymmetric conditional branch instruction along the other of the first and second branches using circuitry configured for non-speculative execution.

3. The method of claim 2,
wherein the processor code along the branch that is speculatively executed accesses a first portion of memory, and
wherein the processor code along the branch that is non-speculatively executed accesses a second portion of memory.

4. The method of claim 3, wherein the first and second portions of memory comprise memory associated with kernels, hypervisors, or sensitive memory.

5. The method of claim 2, wherein the processor code along the branch that is speculatively executed is code that is vulnerable to a speculative side-channel attack.

6. The method of claim 1, further comprising
predicting which one of the first and second branches will be taken at the asymmetric conditional branch instruction;
wherein, if the first branch is predicted and the asymmetric conditional branch instruction permits speculative execution along the first branch, the processor code along the first branch is speculatively executed with results of the speculative execution held in memory pending resolution of the prediction; and
wherein, if the first branch is predicted but the asymmetric conditional branch instruction blocks speculative execution along the first branch, the processor code along the first branch is non-speculatively executed with the non-speculative execution delayed until after the prediction is resolved.

7. The method of claim 6, wherein, if the prediction is correct, the results of the speculative execution following the asymmetric conditional branch instruction are committed and, if the prediction is incorrect, the results are flushed.

8. The method of claim 1, wherein the asymmetric conditional branch instruction is applied to one or more of a Taken branch and a Not Taken branch.

9. A processor, comprising:
a receive device configured to receive processor code having an asymmetric conditional branch instruction, the asymmetric conditional branch instruction permitting speculative execution along one of first and second branches while blocking speculative execution along the other of the first and second branches; and
code execution circuitry configured to execute processor code instructions, including the asymmetric conditional branch instruction.

10. The processor of claim 9, wherein the code execution circuitry is further configured to (a) speculatively execute processor code following the asymmetric conditional branch instruction along one of the first and second branches using circuitry configured for speculative execution, and to (b) non-speculatively execute processor code following the asymmetric conditional branch instruction along the other of the first and second branches using circuitry configured for non-speculative execution.

11. The processor of claim 9, further comprising:
a branch predictor configured to predict which one of the first and second branches will be taken at the asymmetric conditional branch instruction; and
wherein the code execution circuitry is further configured to
speculatively execute the processor code along the first branch, if the first branch is predicted and the asymmetric conditional branch instruction permits speculative execution along the first branch, with results of the speculative execution held in memory pending resolution of the prediction, and
non-speculatively execute the processor code along the first branch, if the first branch is predicted but the asymmetric conditional branch instruction blocks
speculative execution along the first branch, with the non-speculative execution delayed until after the prediction is resolved.

12. The processor of claim 11, wherein the code execution circuitry is further configured so that, if the prediction is correct, the results of the speculative execution following the asymmetric conditional branch instruction are committed and, if the prediction is incorrect, the results are flushed.

13. A method for use by a compiler for converting a computing program to processor code for executing by a processor, the method comprising:
identifying a conditional processing branch in the computing program, the conditional processing branch having a first branch and a second branch;
compiling the computing program into processor code, the processor code including an asymmetric conditional branch instruction inserted at the conditional processing branch to instruct the processor to permit speculative execution along one of the first and second branches while blocking speculative execution along the other of the first and second branches; and
storing the processor code on a non-transitory machine-readable storage medium for subsequent execution by the processor.

14. The method of claim 13, further comprising:
determining if the first branch is of a first type and the second branch is of a second type, and, if so, inserting the asymmetric conditional branch instruction at the conditional processing branch to block speculative access along the first branch while permitting speculative access along the second branch to other portions of memory.

15. The method of claim 14, wherein the first type of branch is a branch susceptible to a speculative side-channel attack and the second type of branch is a branch that is not susceptible to a speculative side-channel attack.

16. The method of claim 14, further comprising:
determining if both the first branch and the second branch are of the first type, and, if so, inserting a symmetric non-speculative branch instruction at the conditional processing branch to block speculative access along both the first branch and the second branch.

17. The method of claim 14, further comprising:
determining if both the first branch and the second branch are of the second type, and, if so, inserting a symmetric speculative branch instruction at the conditional processing branch to permit speculative access along both the first branch and the second branch.

18. The method of claim 13, wherein the asymmetric conditional branch instruction is inserted at one or more of a Taken branch and a Not Taken branch.

19. A compiler configured for converting a computing program to processor code for executing on a processor, the compiler comprising:
a receive component configured to receive a computer program for compiling;
a conditional processing branch identifier configured to identify at least one conditional processing branch in the computing program; and
a code compiler configured to compile the computing program into processor code, the processor code including an asymmetric conditional branch instruction inserted at the conditional processing branch to instruct the processor to permit speculative execution along one of the first and second branches while blocking speculative execution along the other of the first and second branches.

20. The compiler of claim 19, wherein the compiler is further configured to determine if the first branch is of a first type and the second branch is of a second type, and, if so, to insert the asymmetric conditional branch instruction at the conditional processing branch to block speculative access along the first branch while permitting speculative access along the second branch.

21. The compiler of claim 20, wherein the first type of branch is a branch susceptible to a speculative side-channel attack and the second type of branch is a branch that is not susceptible to a speculative side-channel attack.

22. The compiler of claim 20, wherein the code compiler is further configured to determine if both the first branch and the second branch are of the first type, and, if so, to insert a symmetric non-speculative branch instruction at the conditional processing branch to block speculative access along both the first branch and the second branch.

23. The compiler of claim 20, wherein the code compiler is further configured to determine if both the first branch and the second branch are of the second type, and, if so, to insert a symmetric speculative branch instruction at the conditional processing branch to permit speculative access along either the first branch or the second branch.

24. The compiler of claim 19, wherein the asymmetric conditional branch instruction is inserted at one or more of a Taken branch and a Not Taken branch.
